(19) United States
(12) Patent Application Publication
(10) Pub. No.: US 2017/0064138 A1
(43) Pub. Date: Mar. 2, 2017

(54) ORIGINAL READING APPARATUS

(71) Applicant: CANON KABUSHIKI KAISHA, Tokyo (JP)

(72) Inventor: Daisuke Morikawa, Kashiwa-shi (JP)

(21) Appl. No.: 15/222,680

(22) Filed: Jul. 28, 2016

(30) Foreign Application Priority Data
Aug. 24, 2015 (JP) 2015-165149
Jul. 11, 2016 (JP) 2016-137053

(51) Int. Cl. H04N 1/401; H04N 1/48; H04N 1/193

(52) U.S. Cl. CPC H04N 1/401; H04N 1/193; H04N 1/486; H04N 2201/0081

(57) ABSTRACT

An apparatus comprises: a determination unit that determines whether target pixel data of a reference member is a singularity pixel; a counter that counts the number of pixel data that is not determined as the singularity pixel, for each of main-scanning positions; a summation unit that cumulatively sums the target pixel data not determined as the singularity pixel, for each of the main-scanning positions; and a calculation unit that, for each of the main-scanning positions, causes the summation unit to cumulatively sum the target pixel data not determined as the singularity pixel if a count value corresponding to a main-scanning position of the target pixel data is smaller than a predetermined number, and calculates shading correction data using data that the predetermined number of pixel data not determined as the singularity pixel are cumulatively summed.

### BACKGROUND OF THE INVENTION

Field of the Invention

The present invention relates to an original reading apparatus, and in particular to a method of sampling data for generating shading correction coefficients while reducing the influence of dust attached to a white reference member.

Description of the Related Art

Image reading apparatuses are subjected to a mismatch between conversion characteristics of the original luminance of an image and conversion characteristics of a read signal of the image due to the influence of, for example, the pixel-to-pixel variation in reading characteristics of a reading element in a reading sensor, and non-uniformity of light quantity distributions of a light source that illuminates an original. Shading correction has been proposed as a method of correcting such a mismatch pertaining to a read image. In shading correction, a white reference board is read and a shading correction coefficient is generated from the result of reading before the start of image reading.

The white reference board serves as a benchmark for shading correction. Therefore, dust attached to the white reference board could possibly deteriorate the precision of shading correction. For this reason, the white reference board is installed with extreme care in an installation process so as to reduce the amount of attached dust to the maximum. However, it is difficult to completely prevent the attachment of dust. In view of this, a shading correction coefficient is generated under the assumption that a small amount of dust is attached to the white reference board. Numerous methods have been proposed to reduce the influence of dust on the white reference board. For example, in Japanese Patent No. 2736536, a shading correction coefficient is generated by reading a white reference board before image reading, and shading correction is performed accordingly. Furthermore, the reading position is shifted in a sub-scanning direction, the white reference board is read at the shifted reading position, and singularities at the sites where the white reference board was read are detected from the result of reading. If any singularity is found, the reading position is further shifted in the sub-scanning direction in search for sites without singularities in order to generate a shading correction coefficient.

In Japanese Patent Laid-Open No. 2003-32452, shading correction coefficients are generated based on data obtained by reading a white reference board at a first reading position, and shading correction is performed at a second reading position using the generated shading correction coefficients. Furthermore, all pixels are compared with a determination reference to detect abnormal pixels, and modification coefficients are calculated that transform data values of the abnormal pixels after shading correction into a prescribed reference value. Moreover, shading correction coefficients corresponding to certain pixels are multiplied by the modification coefficients, and the products are used as shading correction coefficients in reading an original.

In Japanese Patent No. 2736536, image reading takes long because processing for searching for positions without singularities is executed before every image reading. Furthermore, if there is no position without any singularity, there is a problem of, for example, the appearance of the influence of singularities in an image.

In Japanese Patent Laid-Open No. 2003-32452, it is necessary to determine the sites representing singularities at the second reading position based on data of the white reference board obtained at the first reading position, and calculate modification coefficients for the sites that have been determined as singularities. In this case, the scale of a circuit for realizing calculation processing is increased as it is necessary to execute the calculation processing on a per-singularity basis to obtain the modification coefficients. Furthermore, when this calculation is performed by a CPU, the processing takes relatively long, and hence it takes a large amount of time to read an original.

### SUMMARY OF THE INVENTION

In view of the above problems, the present invention aims to generate shading correction data easily and quickly.

According to one aspect of the present invention, there is provided an original reading apparatus, comprising: a sensor configured to read an original; a shading correction unit configured to apply shading correction to pixel data output from the sensor using shading correction data corresponding to a main-scanning position of the pixel data; a determination unit configured to determine whether target pixel data of a reference member output from the sensor is a singularity pixel; a counter configured, for each of main-scanning positions, to count the number of pixel data that have not been determined as the singularity pixel; a summation unit configured, for each of the main-scanning positions, to cumulatively sum the target pixel data that have not been determined as the singularity pixel; and a calculation unit configured, for each of the main-scanning positions, to cause the summation unit to cumulatively sum the target pixel data that have not been determined as the singularity pixel if a count value corresponding to a main-scanning position of the target pixel data is smaller than a predetermined number, and to calculate the shading correction data using data that the predetermined number of the target pixel data that have not been determined as the singularity pixel are cumulatively summed.

With the present invention, shading correction data can be generated easily and quickly.

Further features of the present invention will become apparent from the following description of exemplary embodiments (with reference to the attached drawings).

### BRIEF DESCRIPTION OF THE DRAWINGS

FIG. 1 is a cross-sectional view of an image reading apparatus.

FIG. 2 shows exemplary configurations of a reading control substrate and a signal processing substrate.

FIG. 3 is a block diagram of a shading correction processing unit.

FIG. 4 is a flowchart of conventional shading correction processing.

FIG. 5 is a flowchart of a procedure of processing for data sampling that achieves elimination of dust on a white reference board.

FIGS. 6A and 6B are diagrams for describing the influence of dust and determination thresholds pertaining to singularity determination.

FIG. 7 is a diagram for describing an operational flow according to the present invention.

FIG. 8 is a diagram for describing the concept of data sampling according to the present invention.

### DESCRIPTION OF THE EMBODIMENTS

The following describes a method of calculating shading correction coefficients according to the present invention, with reference to the drawings.

### First Embodiment

### Configuration of Image Reading Apparatus

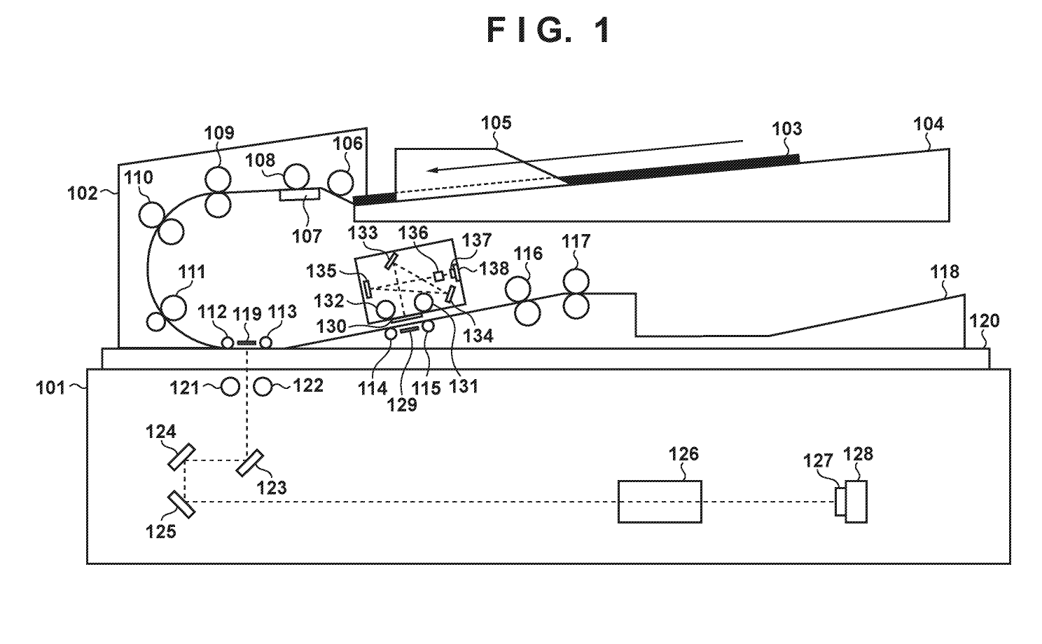

FIG. 1 is a cross-sectional view of an image reading apparatus as an original reading apparatus. Note that the configuration of the image reading apparatus shown in this figure is an example, and an image reading apparatus to which the invention of the present application is applicable is not limited to having this configuration. The image reading apparatus according to the present embodiment includes a reader unit 101 that reads originals, and an automatic original conveyance apparatus (hereinafter, ADF) 102 that conveys the originals. A stack of originals 103 is placed on an original tray 104. Oblique conveyance of the originals is suppressed by contact between an edge of the stack of originals 103 and a width restriction plate 105. The stack of originals 103 is carried by a pickup roller 106 to a separation unit that includes a separation pad 107 and a separation roller 108. In the separation unit, the separation pad 107 and the separation roller 108 separate the stack of originals 103 from one another in order, starting from the topmost sheet.

A first registration roller 109 corrects oblique conveyance of an original that has been separated, and then the original is conveyed by a second registration roller 110, a first conveyance roller 111, a second conveyance roller 112, and a third conveyance roller 113 in this order. When the original passes the second conveyance roller 112 and the third conveyance roller 113, the original passes over a first reading position, and the image reading apparatus obtains image information of a front surface of the original. After passing the third conveyance roller 113, the original is conveyed by a fourth conveyance roller 114 and a fifth conveyance roller 115. At this time, the image reading apparatus reads image information of a back surface of the original when the original passes over a second reading position. Thereafter, the original is conveyed by a sixth conveyance roller 116 and a discharge roller 117, and then discharged onto an original discharge tray 118.

A description is given of the operation of reading the front surface of the original. While the original is passing between a white opposing member 119 at the first reading position and a reading glass 120, light sources 121 and 122 illuminate the original, and light reflected from the original is guided by reflection mirrors 123, 124, and 125 to an imaging lens 126. The light is converged by the imaging lens 126 to form an image on a line sensor 127 in which image sensors, such as charge-coupled devices (CCDs), are arranged on a line. Light signals of the formed image are converted by the line sensor 127 into electrical signals, and then converted by a signal processing substrate 128 into digital signals which are used in image processing.

A description is now given of the operation of reading the back surface of the original. While the original is passing between a white opposing member 129 and a back surface reading glass 130 at the second reading position, light sources 131 and 132 illuminate the original, and light reflected from the original is guided by reflection mirrors 133, 134, and 135 to an imaging lens 136. Similarly to the case of the front surface, the light is converged by the imaging lens 136 to form an image on a line sensor 137 in which image sensors, such as charge-coupled devices (CCDs), are arranged on a line. Light signals of the formed image are converted by the line sensor 137 into electrical signals, and then converted by a signal processing substrate 138 into digital signals which are used in image processing.

In an ordinary configuration, a common reading unit is used for a flow-reading operation in which an image of the front surface of the original is read while the original is conveyed, and for a fixed-reading operation in which the original placed on the reading glass 120 is read. The present embodiment adopts a configuration in which, during fixed-reading, the original placed on the reading glass 120 can be read by moving the light sources 121 and 122 and the reflection mirror 123 from left to right in FIG. 1. On the other hand, a unit that reads the back surface of the original in flow-reading is fixedly mounted on a housing of the ADF as it does not need to move.

Note that in the present embodiment, in the case of the flow-reading operation, the direction of conveyance of the original is a sub-scanning direction, whereas the direction perpendicular to the sub-scanning direction is a main-scanning direction. In the case of the fixed-reading operation, the direction of movement of the reading unit is the sub-scanning direction, and the direction perpendicular to the sub-scanning direction is the main-scanning direction. [Configurations of Control Units of Image Reading Apparatus]

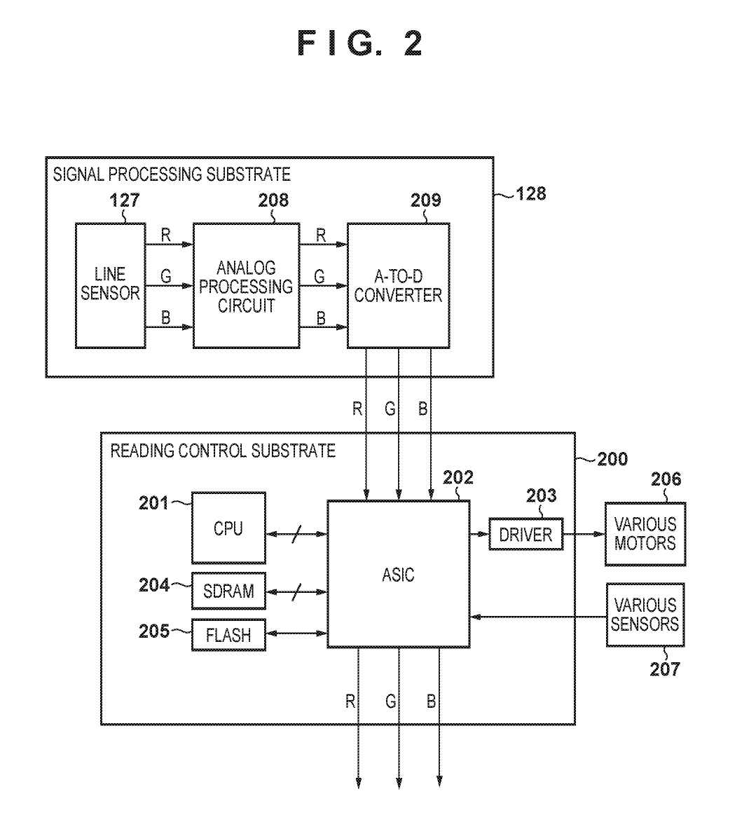

FIG. 2 shows exemplary configurations of a reading control substrate 200 and the signal processing substrate 128 of the image reading apparatus according to the present embodiment. Note that the configurations of the control units shown in this figure are examples, and the control units are not limited to having these configurations.

The signal processing substrate 128 is composed of the line sensor 127, an analog processing circuit 208, an A-to-D converter 209, and the like. Reflected/scattered light generated by the light sources illuminating the original is photoelectrically converted by the line sensor 127 via an optical system shown in FIG. 1. The photoelectric conversion yields analog signals corresponding to the colors R, G, and B, and the analog processing circuit 208 applies offset adjustment and gain adjustment to the analog signals. The subsequent A-to-D converter 209 converts the analog signals adjusted by the analog processing circuit into digital signals, and inputs the converted digital image signals to an ASIC 202.

The reading control substrate 200 is composed of a CPU 201, the ASIC 202, a motor driver 203, an SDRAM 204, and a flash memory 205. The ASIC 202 or CPU 201 controls input signals of various sensors 207, not shown in FIG. 1, and control output signals of various motors 206, not shown in FIG. 1, in the image reading apparatus.

For example, the CPU 201 configures various operational settings of the ASIC 202. Once the CPU 201 has configured such settings, the ASIC 202 applies various types of image processing to the digital image signals input from the A-to-D converter 209. During this image processing, the ASIC 202 also exchanges various control signals and image signals with the SDRAM 204 to, for example, temporarily save image signals. A part of various setting values and image processing parameters of the ASIC 202 is stored to the flash memory 205, and the stored data and parameters are read out for use as necessary.

The ASIC 202 performs a sequence of image reading operations by starting image processing and outputting control pulses for various motors to the motor driver 203, using a command from the CPU 201 or an input sensor signal as a trigger. Note that after the ASIC 202 has applied various types of image processing to image data, the image data is passed to a subsequent main control substrate (not shown).

[Configuration of Shading Correction Unit]

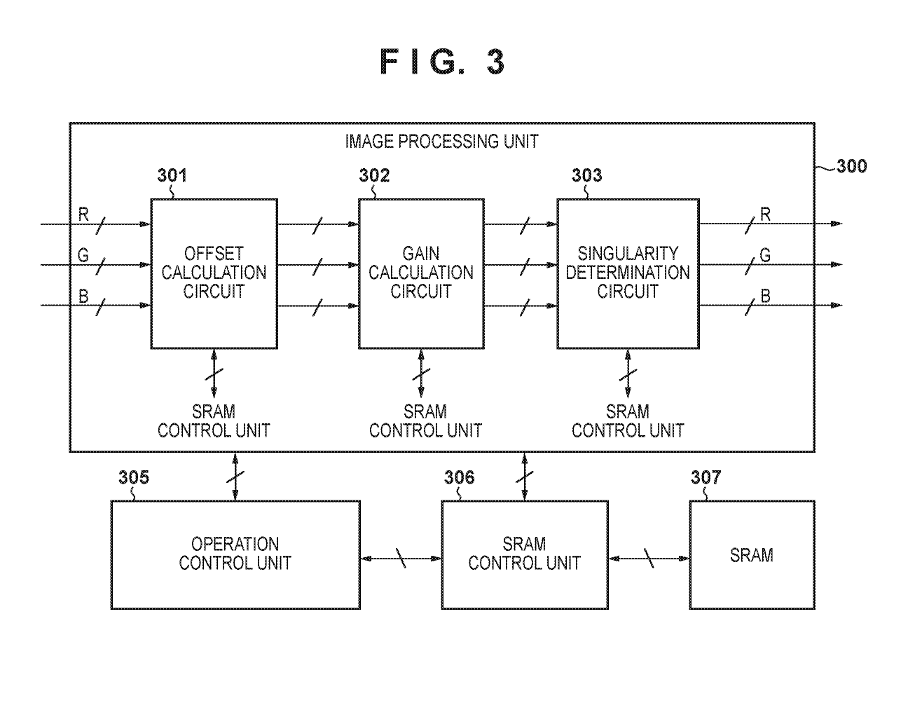

FIG. 3 is a schematic view of circuits that compose an image processing unit 300 included in the ASIC 202, and that execute shading correction processing and calculation of shading correction data.

The image processing unit 300 includes an offset calculation circuit 301, a gain calculation circuit 302, and a singularity determination circuit 303. The offset calculation circuit 301 corrects the pixel-to-pixel variation in dark output of the line sensor 127. The gain calculation circuit 302 corrects the pixel-to-pixel variation in light output of the line sensor 127, which coincides with, for example, a reduction in the light quantity of a peripheral region of an image attributed to the light distribution of the light source 121 in the main-scanning direction and the imaging lens 126. The singularity determination circuit 303 compares a read image with predetermined determination thresholds, and determines a pixel that exceeds or falls below the thresholds as a singularity pixel (an abnormal pixel). In the present specification, a pixel having a pixel value attributed to the dust or smear attached to a white reference board, which is a reference member used in singularity detection, is referred to as a “singularity pixel.” The details of this determination will be described later with reference to flowcharts.

For example, an operation control unit 305 sets ON/OFF of various calculation operations and various parameters of the calculation circuits included in the image processing unit 300, and configures operational settings of an SRAM control unit 306. Based on commands from the operation control unit 305, the SRAM control unit 306 writes data to and reads out data from an SRAM 307 included in the ASIC 202, and executes calculation processing. Various calculation circuits included in the image processing unit 300 are also connected to the SRAM control unit 306. For example, various calculation circuits read out, from the SRAM 307, offset coefficients, gain coefficients, and dust determination thresholds that are stored in the SRAM 307 on a per-pixel basis as necessary, and perform necessary calculations based on read values and input image signals.

The offset calculation circuit 301 subtracts offset values from the input image signals based on the following Expression 1. It will be assumed that these offset values are held in the SRAM 307 in one-to-one correspondence with positions along the main-scanning direction. The same element appearing in the mathematical expressions described below refers to the same entity. In the present specification, “sampling summation” denotes sampling of pixel values and sequential summation of the pixel values.

O_DATA[x]=I_DATA[x]−BW_RAM_DATA[x] Expression 1

x: main-scanning position

O_DATA [x]: a value at a main-scanning position x among output data that is output from the offset calculation circuit 301

I_DATA [x]: a value at the main-scanning position x among input data that is input to the offset calculation circuit 301

BW_RAM_DATA [x]: a value at the main-scanning position x among the offset values held in the SRAM 307.

BW_RAM_DATA [x] is calculated by subtracting dark output data of the line sensor 127 following the A-to-D conversion from averaged data that is obtained by sampling pixel values over multiple lines, summing the sampled pixel values, and dividing the sum by the number of lines from which the sampled pixel values have been obtained for each main-scanning position.

BW_RAM_DATA can be calculated using the following Expression 2.

BW_RAM_DATA[x]=(average value of sampling summation data[x])−BW_TARGET Expression 2

Average value of sampling summation data [x]: average value of sampling summation data at the main-scanning position x

BW_TARGET: target value of dark output data

Based on the following Expression 3, the gain calculation circuit 302 multiplies the input image signals to the gain calculation circuit 302 by gain values. It will be assumed that these gain values are held in the SRAM 307 in one-to-one correspondence with the positions along the main-scanning direction. As shown in FIG. 3, output data that is output from the offset calculation circuit 301 (O_DATA [x] in Expression 1) corresponds to input data that is input to the gain calculation circuit 302 (I_DATA [x] in Expression 3).

O_DATA[x]=I_DATA[x]×WH_RAM_DATA[x] Expression 3

x: main-scanning position

O_DATA [x]: a value at the main-scanning position x among output data that is output from the gain calculation circuit 302

I_DATA [x]: a value at the main-scanning position x among input data that is input to the gain calculation circuit 302

WH_RAM_DATA [x]: a value at the main-scanning position x among the gain values held in the SRAM 307

WH_RAM_DATA [x] is calculated by dividing light output data of the line sensor 127 following the A-to-D conversion by averaged data that is obtained by sampling pixel values over multiple lines, summing the sampled pixel values, and dividing the sum by the number of lines from which the sampled pixel values have been obtained for each main-scanning position. WH_RAM_DATA [x] can be calculated using the following Expression 4.

WH_RAM_DATA[x]=SHD_TARGET=(average value of sampling summation data[x]) Expression 4

SHD_TARGET: target value of shading correction

Based on the following Expressions 5 and 6, the singularity determination circuit 303 performs a comparison operation, that is to say, compares the input image signals to itself with thresholds, for each main-scanning position. The singularity determination circuit 303 also outputs the result of the comparison operation (the determination result) to the SRAM control unit 306, as well as the input image signals input thereto as-is. As shown in FIG. 3, output data that is output from the gain calculation circuit 302 (O_DATA [x] in Expression 3) corresponds to input data that is input to the singularity determination circuit 303 (I_DATA [x] in Expressions 5 and 6).

OVER_FLAG=1@I_DATA[x]>OVER_TH[x]

=0@I_DATA[x]≦OVER_TH[x] Expression 5

UNDER_FLAG=1@I_DATA[x]<UNDER_TH[x]

=0@I_DATA[x]≧UNDER_TH[x] Expression 6

x: main-scanning position

O_DATA [x]: value at the main-scanning position x among output data that is output from the singularity determination circuit 303

I_DATA [x]: value at the main-scanning position x among input data that is input to the singularity determination circuit 303

OVER_TH: singularity determination threshold (upper limit)

UNDER_TH: singularity determination threshold (lower limit)

In Expressions 5 and 6, OVER_FLAG=1 applies when input data is larger than OVER_TH. On the other hand, UNDER_FLAG=1 applies when input data is smaller than UNDER_TH. In other words, portions that follow the “@” sign indicate conditions regarding output values. The same goes for the mathematical expressions described below.

Although the same singularity determination thresholds may be used for all pixels, a higher-precision determination that addresses pixel variations can be made by changing the singularity determination thresholds for each main-scanning position. Specifically, the singularity determination thresholds can be changed for each main-scanning position by storing, to the SRAM 307, pieces of data serving as prerequisites for the singularity determination thresholds for each main-scanning position, and using predetermined luminance differences from the stored pieces of data as the singularity determination thresholds. For example, when pieces of data serving as prerequisites for the main-scanning positions x=10 and x=11 are 180 and 185, respectively, the upper limit thresholds are set to 190 and 195, respectively, and the lower limit thresholds are set to 170 and 175, respectively. Although a luminance difference of “10” is used in obtaining both the upper limit thresholds and the lower limit thresholds in the foregoing description, no restriction is intended in this regard. Luminance differences used in obtaining the upper limit thresholds and the lower limit thresholds may vary. With the present processing, singularities in input image data are determined.

[Processing for Calculating Shading Correction Data]

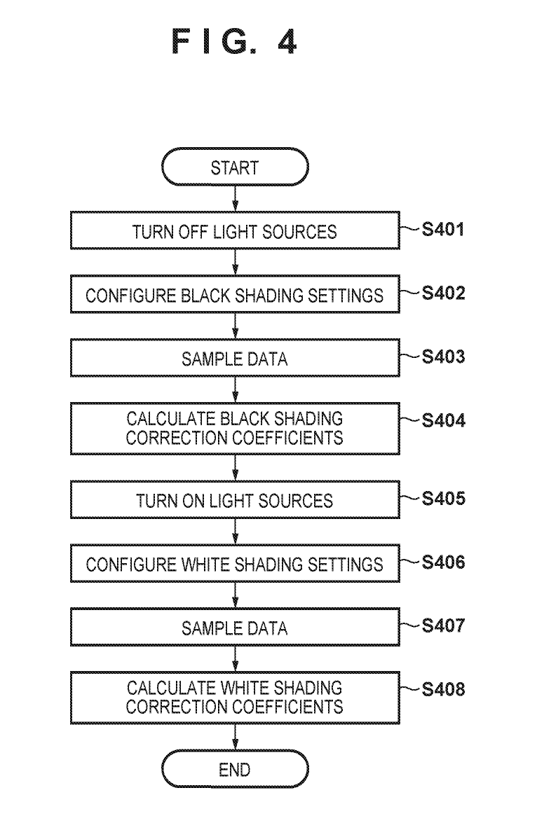

The following describes processing for calculating shading correction data serving as a prerequisite for the present embodiment, with reference to FIG. 4.

In step S401, the image reading apparatus turns OFF the light sources 121 and 122 for first reading unit, or the light sources 131 and 132 for second reading unit, shown in FIG. 1.

In step S402, the operation control unit 305 configures black shading correction settings of the calculation circuits shown in FIG. 3. Specifically, all of the offset calculation circuit 301, the gain calculation circuit 302, and the singularity determination circuit 303 are set to execute no processing (that is to say, set to skip processing).

In step S403, the image reading apparatus performs data sampling for the purpose of generating black shading correction coefficients. Specifically, the image reading apparatus stores output data of the singularity determination circuit 303 to the SRAM 307 based on the settings configured in step S402.

In step S404, the SRAM control unit 306 calculates average values of sampling summation data from image data stored in the SRAM 307, and calculates the black shading correction coefficients (BW_RAM_DATA) based on Expression 2. Then, the SRAM control unit 306 stores the calculated black shading correction coefficients (BW_RAM_DATA) to the SRAM 307.

In step S405, the image reading apparatus turns ON the light sources that were turned OFF in step S401.

In step S406, the image reading apparatus configures white shading correction settings.

Specifically, the image reading apparatus sets the black shading correction coefficients (BW_RAM_DATA) in the offset calculation circuit 301, and sets the singularity determination circuit 303 to execute determination processing. On the other hand, the image reading apparatus sets the gain calculation circuit 302 to execute no processing (that is to say, to skip processing).

In step S407, the image reading apparatus samples image data of the white reference board for the purpose of generating white shading correction coefficients. Specifically, the image reading apparatus stores image data output from the singularity determination circuit 303 to the SRAM 307 based on the settings configured in step S406. The image reading apparatus also stores the result of determination by the singularity determination circuit 303 to the SRAM 307. Here, in order to calculate shading correction data for image data output from the line sensor 127, sampling of the image data is performed using the white opposing member 119 as the white reference board. On the other hand, in order to calculate shading correction data for image data output from the line sensor 137, sampling of the image data is performed using the white opposing member 129 as the white reference board.

In step S408, the SRAM control unit 306 calculates average values of sampling summation data based on the image data and the determination result stored in the SRAM 307, and calculates the white shading correction coefficients (WH_RAM_DATA) from the average values of the sampling summation data based on Expression 4. Then, the SRAM control unit 306 stores the white shading correction coefficients (WH_RAM_DATA) to the SRAM 307.

[General Description of Algorithms for Calculating Shading Correction Data (Steps S407 and S408) According to the Present Embodiment]

Various calculation circuits included in the ASIC 202 shown in FIG. 3 obtain shading correction data. A processing procedure is characterized by the following two points.

(1) Determine whether a target pixel is a singularity (an abnormal pixel).

(2) If the target pixel is not a singularity, data sampling is performed with respect to the target pixel. If the target pixel is a singularity, data sampling is not performed with respect to the target pixel.

First, the singularity determination of (1) is made to determine whether data sampling of (2) is to be performed with respect to the target pixel.

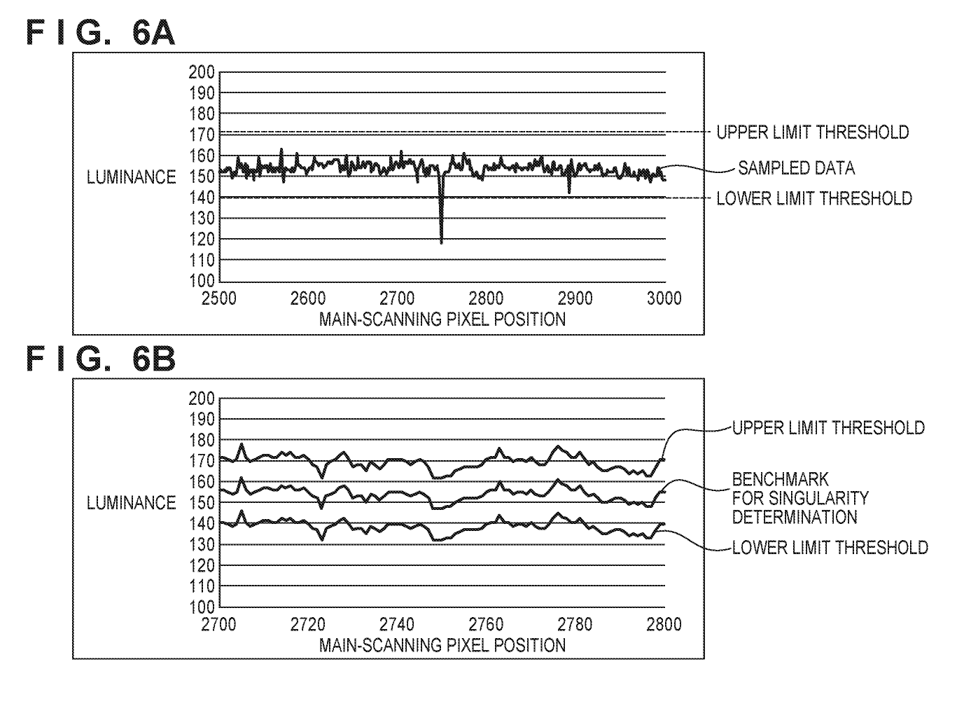

FIGS. 6A and 6B show a part of image data of the white reference board along the main-scanning direction; the image data has been sampled in calculating the dust determination thresholds. In FIGS. 6A and 6B, a horizontal axis represents pixel positions on a line along the main-scanning direction, and a vertical axis represents read luminance values. Upper limit thresholds and lower limit thresholds set for the luminance values serve as benchmarks for determining whether each pixel is a singularity. FIG. 6A shows a range of 140 to 170 set for the luminance values, and any pixel having a luminance value outside this range is determined as a singularity. In FIG. 6A, there is a site with a low luminance value of approximately 118 near the 2750^{th} pixel; this site is determined as a singularity because its luminance value falls below the lower limit threshold.

To reduce the influence of such a singularity, data sampling of (2) is not performed with respect to read data (pixel) of a site having a luminance value that has been determined to exceed or fall below the determination thresholds of (1). That is to say, sampling of only data other than singularities makes it possible to obtain data that more accurately reflects the pixel-to-pixel variation in reading characteristics while maintaining the state where the influence of singularities has been eliminated.

By thus sampling data based on the aforementioned singularity determination, data suitable for shading correction can be obtained in the state where the influence of dust on the white reference board has been reduced.

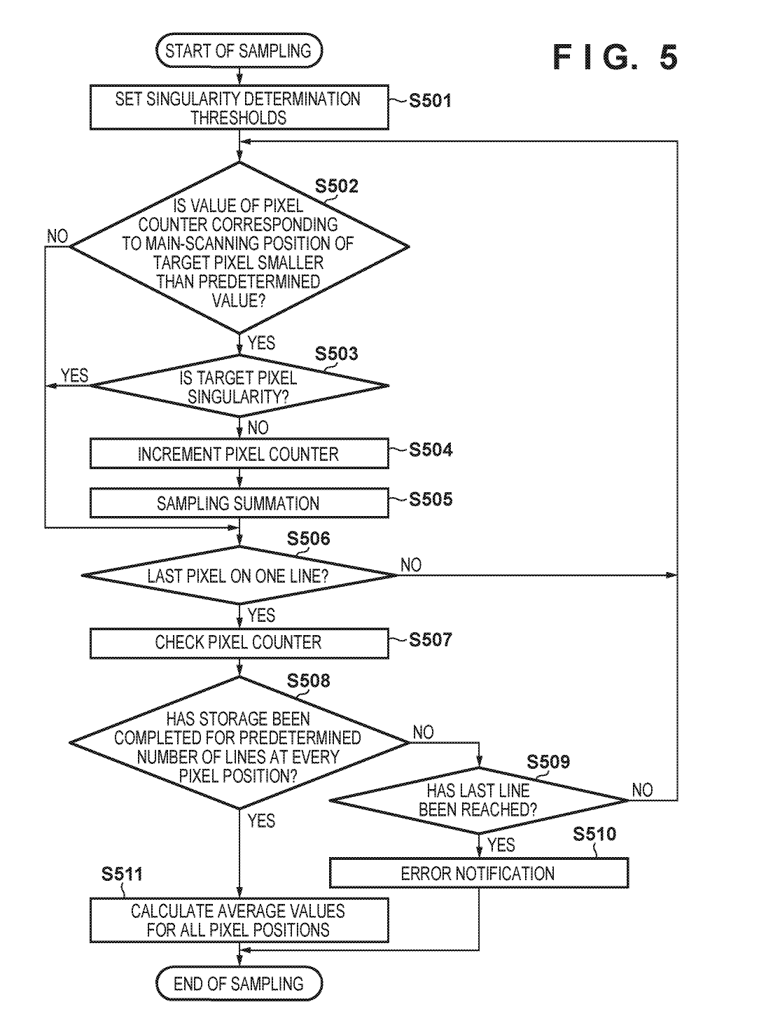

FIG. 5 is a flowchart of a procedure for obtaining shading correction data according to the present embodiment.

In step S501, the operation control unit 305 sets the singularity determination thresholds. The process of step S501 is a part of the process of step S406 in FIG. 4. The following are two examples of a method of designating a specific luminance value range.

(a) An upper limit and a lower limit of luminance values are designated as fixed values for all pixels.

With this setting method, as shown in FIG. 6A, whether each target pixel is a singularity is determined based on whether a luminance value of the target pixel falls within the luminance value range defined by the fixed values.

(b) A relative luminance value range is designated for each pixel position along the main-scanning direction.

With this setting method, as shown in FIG. 6B, a luminance value serving as a benchmark for singularity determination is set for each pixel position along the main-scanning direction, and a predetermined range (an upper limit and a lower limit) is designated with respect to the benchmark for singularity determination. Here, a fixed value is designated as the predetermined range (the upper limit and the lower limit) with respect to the benchmark for singularity determination. Then, whether each target pixel is a singularity is determined based on whether a luminance value of the target pixel falls within the predetermined range. This setting method requires reference data serving as a benchmark for singularity determination on a per-pixel basis. The result of sampling of the white reference board over multiple lines prior to data sampling for shading correction can be used as this reference data. Alternatively, average values of the result of advance sampling of the white reference board over multiple lines prior to the start of reading operations may be used as this reference data. Alternatively, read data of the white reference board at the time of factory shipment may be stored to a non-volatile memory, such as a flash ROM, and the stored data may be read out from the non-volatile memory for use as this reference data when the power of the apparatus is turned ON.

Similarly to the reference data for singularity determination, provisional shading correction coefficients may be calculated based on average values of the result of advance sampling of the white reference board over multiple lines. Alternatively, provisional shading correction coefficients may be generated from read data of the white reference board at the time of factory shipment.

In step S502, the SRAM control unit 306 regards a certain pixel included in a target line as a target pixel, and determines whether a value of a pixel counter corresponding to a main-scanning position of the target pixel is smaller than a predetermined value. The SRAM control unit 306 has pixel counters that are in one-to-one correspondence with main-scanning positions. For example, when ten pixels are arranged in the main-scanning direction, a total of ten pixel counters are provided in one-to-one correspondence with the positions (main-scanning positions) of the ten pixels. The predetermined value corresponds to the later-described number of sampling summation lines, and can be set to, for example, “64.” If the value of the pixel counter corresponding to the main-scanning position of the target pixel is smaller than the predetermined value (YES of step S502), processing proceeds to step S503. On the other hand, if the value of the pixel counter corresponding to the main-scanning position of the target pixel is equal to or larger than the predetermined value (NO of step S502), processing proceeds to step S506 without executing the processes of steps S503 to S505.

In the present processing flow, values of pixels other than singularities are cumulatively summed in the processes of steps S503 to S505. Here, if it is determined in step S502 that the value of the pixel counter corresponding to the main-scanning position of the target pixel has reached the predetermined value (the number of sampling summation lines), control is performed in such a manner that the summation processes are not executed with respect to that main-scanning position. The number of sampling summation lines denotes the number of lines necessary for sampling whereby pixels that have not been determined as singularities are selected as sampling targets and values of the sampling targets are sequentially summed. Therefore, in the processes of steps S503 to S505, values of pixels that are located at a certain main-scanning position and are other than singularities are cumulatively summed until a value of the pixel counter corresponding to that main-scanning position reaches the number of sampling summation lines. That is to say, processing is based on the assumption that the shading correction coefficients can be calculated appropriately as long as sampling has been completed over the number of sampling summation lines. Any number may be set as the number of sampling summation lines (the aforementioned predetermined value) in accordance with the processing load and precision.

In step S503, the singularity determination circuit 303 determines whether the target pixel is a singularity pixel using the singularity determination thresholds set in step S501. Then, the singularity determination circuit 303 stores the determination result and input image data of each pixel to the SRAM 307. Furthermore, the SRAM control unit 306 sequentially reads out the image data and determination results from the SRAM 307. Subsequent steps S504 and S505 are not executed with respect to the target pixel if the target pixel has been determined as a singularity pixel. If the target pixel has been determined as a singularity (YES of step S503), processing proceeds to step S506; if the target pixel has not been determined as a singularity (NO of step S503), processing proceeds to step S504.

In step S504, the SRAM control unit 306 increments the pixel counter corresponding to the main-scanning position of the target pixel that has not been determined as a singularity in step S503.

In step S505, the image reading apparatus cumulatively sums image data of the target pixel that was not determined as a singularity in step S503.

In step S506, the SRAM control unit 306 determines whether the main-scanning position of read image data is the last position on one line. That is to say, it determines whether the target pixel is located at the last main-scanning position on the target line. If the main-scanning position of the read image data is the last position (YES of step S506), processing proceeds to step S507; if the main-scanning position of the read image data is not the last position (NO of step S506), processing returns to step S502 to continuously make the singularity determination with respect to a new target pixel on the same target line.

In step S507, the SRAM control unit 306 checks the smallest value among the values of the pixel counters of all main-scanning positions. If the smallest value is smaller than the aforementioned number of sampling summation lines after the maximum value of the pixel counter has reached the aforementioned number of sampling summation lines, it indicates that there is a pixel(s) that has not been sampled due to the influence of the dust and smear on the white reference board.

In step S508, the SRAM control unit 306 determines whether the smallest value among the values of the pixel counters checked in step S507 is equal to or larger than the predetermined value (the number of sampling summation lines). If the smallest value is equal to or larger than the predetermined value (YES of step S508), it indicates that sampling has been completed for all main-scanning positions, and hence the sampling operation is ended and processing proceeds to step S511. If the smallest value is not equal to or larger than the predetermined value (NO of step S508), processing proceeds to step S509.

In step S509, the SRAM control unit 306 determines whether the target line is the last line in a sampling range. If the target line is the last line (YES of step S509), processing proceeds to step S510. In this case, sampling has not been completed within a desired range (composed of a prescribed number of lines) of the white reference board. Normally, the sampling range is set to be larger than the number of sampling summation lines. If the target line is not the last line (NO of step S509), processing returns to step S502 to set a new line as a target line and continue processing with respect to each pixel in the new target line.

In step S510, the SRAM control unit 306 notifies the CPU 201 of error indicating a failure in sampling of a predetermined number of pixels. Thereafter, the SRAM control unit 306 ends the sampling processing. Upon being notified of the error, the CPU 201 may issue an error message to a console unit (not shown) as necessary.

In step S511, the SRAM control unit 306 calculates, for each main-scanning position, an average value of sampling summation data by dividing the result of sampling summation by the counter value (the number of sampling summation lines) of the main-scanning position. Then, the white shading correction coefficients (WH_RAM_DATA) are calculated from the average values of the sampling summation data based on Expression 4, and stored to the SRAM 307. Thereafter, the present processing flow is ended.

[Description of Operations]

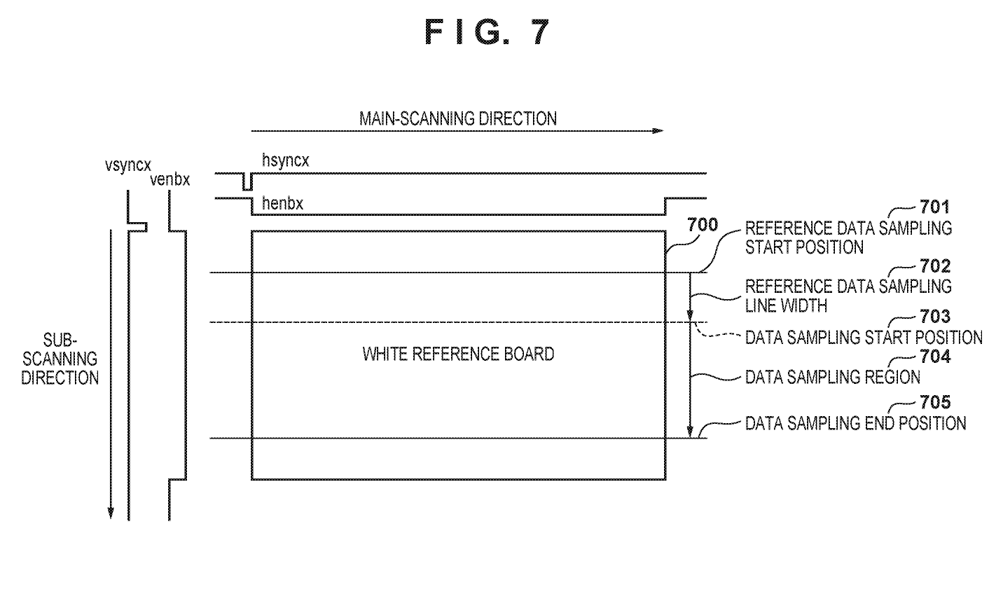

FIG. 7 is a timing chart showing, for example, timings to obtain data according to the present invention. In FIG. 7, a synchronization signal hsyncx indicates a start position of an image in the main-scanning direction, and an enable signal henbx indicates an effective range of the image in the main-scanning direction. A synchronization signal vsyncx indicates a start position of the image in the sub-scanning direction (the direction perpendicular to the main-scanning direction), and an enable signal venbx indicates the effective range of the image in the sub-scanning direction. These signals are generated in the ASIC 202, and reception of these signals by the image processing unit 300 enables detection of the leading end and effective range of the image.

In the image reading apparatus, vsyncx is used to detect the leading end of the image of the white reference board that is used to obtain data for shading correction. Timings to obtain data in the sub-scanning direction are generated upon the start of operation of a line counter Vcnt in the operation control unit 305.

A reference data sampling start position 701 indicates a timing to start sampling of reference data for the singularity determination set in step S501 of the flowchart in FIG. 5, or data for calculating provisional shading correction coefficients. A reference data sampling line width 702 indicates the number of data sampling lines from the reference data sampling start position 701. Timings to start and end sampling of the reference data can be detected based on a value counted by the line counter Vcnt. After sampling summation has been performed across the reference data sampling line width 702, a time period corresponding to a few lines in the sub-scanning direction is consumed to generate the reference data by averaging the summed data, or to calculate the provisional shading correction coefficients.

A timing to start data sampling in step S502 of FIG. 5 can be detected when the line counter Vcnt has been incremented and reached a data sampling start position 703 shown in FIG. 7. A data sampling region 704 indicates a region in which the sequence of data sampling processes in FIG. 5 is executed. A data sampling end position 705 can be detected based on the value counted by the line counter Vcnt. If a line located at this position is reached without completing the sampling, sampling error is issued as shown in step S510 of FIG. 5.

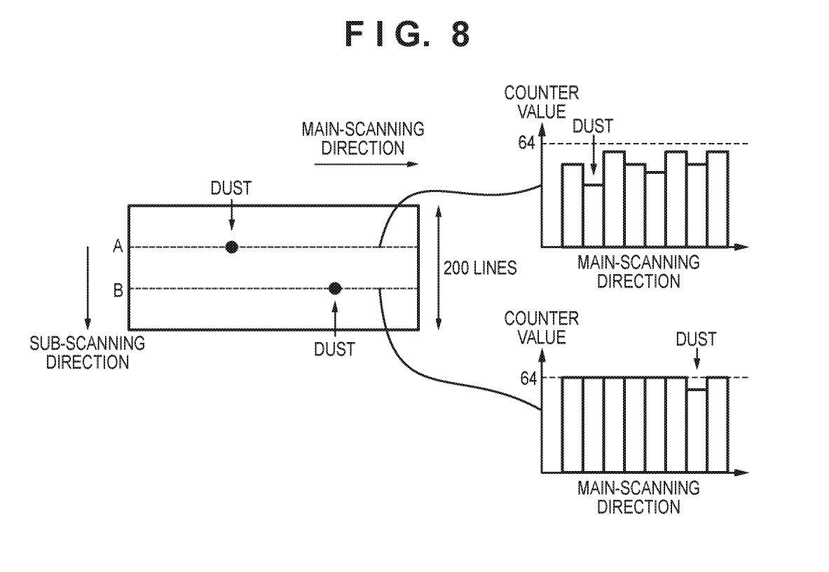

FIG. 8 is a diagram for describing the concept of data sampling according to the present invention, and shows graphs indicating the states of counter values on specific lines within the data sampling region 704 shown in the operational flow of FIG. 7 in relation to main-scanning positions along the main-scanning direction.

On line A, only a pixel located at the position of dust cannot be sampled, and a corresponding counter value is not incremented. At this point, on line A, counter values corresponding to pixels other than the pixel located at the position of dust vary. This is based on the assumption that there were pixels affected by the dust and smear (singularity pixels) up to this point during processing. That is to say, as the positions of dust and smear are not counted, counter values could possibly vary during processing. The states of counter values are determined on a per-line basis, as has been described with reference to step S507 of FIG. 5.

On line B, counter values corresponding to pixels other than a pixel located at the position of dust are all equal to or larger than a predetermined counter value (64 lines). If the data sampling end position 705 shown in FIG. 7 is reached in this state, sampling error is issued because sampling has not been completed for all main-scanning positions. On the other hand, assume a case in which the line B is a target line and falls within the range of the data sampling region 704. In this case, in processing for the next line, counting and sampling processes are continuously executed only with respect to a main-scanning position(s) whose counter value(s) was smaller than the predetermined value (here, 64 counts) on line B.

The sampling operation is ended immediately when sampling has been completed for all main-scanning positions before the data sampling end position 705 is reached (here, when the counter values corresponding to all pixel positions have reached 64).

FIG. 7 shows an example in which sampling of reference data and sampling of shading correction data are performed in the processing flow. Alternatively, as mentioned earlier, the result of advance sampling of the white reference board over multiple lines prior to the start of reading operations may be stored to the SRAM 307 as the reference data. Alternatively, read data of the white reference board at the time of factory shipment may be stored to a non-volatile memory, such as a flash ROM, and the stored data may be read out from the non-volatile memory for use as the reference data when the power of the apparatus is turned ON. In this case, the sampling operation for the reference data can be omitted.

As described above, the invention of the present application does not require calculation circuits for division and multiplication that have been conventionally required to calculate a modification coefficient for a site that has been determined as a singularity. Furthermore, in modification of a singularity by the CPU, a time period of modification processing can be reduced. Therefore, even if dust is attached to the white reference board, shading correction data can be obtained easily and quickly while eliminating the influence of the dust.

### Second Embodiment

The present embodiment pertains to a case in which dust resembling stripes that are continuous in the sub-scanning direction is attached in the data sampling region 704 shown in FIG. 7. In this case, there is a possibility that data sampling will succeed if the CPU is notified of sampling error, a user is prompted to clean the white reference board, and data sampling is performed again after the cleaning. However, as such cleaning is a burden on the user, it is desirable that the image reading apparatus completes processing by itself without troubling the user.

In view of this, the following processes can be additionally executed with respect to data of main-scanning positions for which sampling over a predetermined number of lines was not completed.

(1) Generate data from a range in which sampling has been completed
(2) Replace a value of a singularity pixel with reference data

With the method (1), when data sampling has not been completed at a pixel position X along the main-scanning direction (main-scanning position X) due to the influence of one or more singularities, provided that the number of lines over which sampling has been completed at the pixel position X is L, the divisor used in the averaging process is changed only for data of the pixel position X. It will be assumed that sampling over 64 lines is normally required, similarly to the first embodiment.

Average value=value obtained by sampling summation/L@the pixel position X

=value obtained by sampling summation/64@pixel positions other than the pixel position X

By thus changing a part of processing for singularity pixels as opposed to other pixels, processing can be completed with an image quality level that practically has no influence, although only the pixel positions of the singularity pixels could possibly suffer a slight drop in the correction precision.

However, when L has an extremely small value, only the pixel positions of the singularity pixels could possibly appear as stripes. Furthermore, as there are influences of reading error caused by noise of a reading sensor, temporal changes in the light sources in a short period of time, and so on, it is necessary to perform sampling over the predetermined number of lines or more to reduce such influences.

Therefore, when the number of lines L over which sampling has been completed is smaller than a predetermined value at the pixel position X in the main-scanning direction, it is desirable to use the method (2) instead of using the obtained sampling data. It will be assumed that the predetermined value corresponding to the number of lines L is predefined, and the predetermined value may be decided on in accordance with, for example, the resolution and the image size.

With the method (2), provided that reference data and sampling data corresponding to the pixel position X representing a singularity pixel are DATA_K (X) and DATA_S (X), respectively, DATA_S (X) is replaced with DATA_K (X). However, if DATA_S (X) is simply replaced with DATA_K (X), a stripe could possibly appear in the end when only the post-replacement value of the pixel position X significantly differs from pieces of sampling data DATA_S (X−1) and DATA_S (X+1) of adjacent pixels (pixel positions X−1 and X+1).

In view of this, an offset coefficient OFST is calculated that makes an average value of the pieces of reference data DATA_K (X−1) and DATA_K (X+1) at the pixels adjacent to the pixel position X equal to an average value of DATA_S (X−1) and DATA_S (X+1). Adding the offset coefficient OFST to DATA_K (X) can reduce the influence of stripes caused by a large change in the level. Note that the offset coefficient OFST may take a negative value. The following is a conversion formula.

$$OFST = \frac{DATA\_S ( X - 1 ) + DATA\_S ( X + 1 )}{2} - \frac{DATA\_K ( X - 1 ) + DATA\_K ( X + 1 )}{2}$$

$${DATA\_S}^{′} ( X ) = DATA\_K ( X ) + OFST$$

Here, DATA_S′ (X) is post-replacement data of the pixel position X.

By sampling shading correction data with the addition of the foregoing processes, preferable shading correction coefficients can be obtained for singularity pixels for which data sampling has not been completed in a predetermined region.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-165149, filed Aug. 24, 2015, and No. 2016-137053, filed Jul. 11, 2016, which are hereby incorporated by reference herein in their entirety.

What is claimed is:

1. An original reading apparatus, comprising:
a sensor configured to read an original;
a shading correction unit configured to apply shading correction to pixel data output from the sensor using shading correction data corresponding to a main-scanning position of the pixel data;
a determination unit configured to determine whether target pixel data of a reference member output from the sensor is a singularity pixel;
a counter configured, for each of main-scanning positions, to count the number of pixel data that have not been determined as the singularity pixel;
a summation unit configured, for each of the main-scanning positions, to cumulatively sum the target pixel data that have not been determined as the singularity pixel; and
a calculation unit configured, for each of the main-scanning positions, to cause the summation unit to cumulatively sum the target pixel data that have not been determined as the singularity pixel if a count value corresponding to a main-scanning position of the target pixel data is smaller than a predetermined number, and to calculate the shading correction data using data that the predetermined number of the target pixel data that have not been determined as the singularity pixel are cumulatively summed.

2. The original reading apparatus according to claim 1, further comprising
a holding unit configured to hold reference data for the reference member, wherein
the calculation unit replaces pixel data that has been determined as a singularity pixel by the determination unit with the reference data corresponding to a position of the pixel data that has been determined as the singularity pixel, and causes the summation unit to perform the cumulative summation using a result of the replacement.

3. The original reading apparatus according to claim 1, further comprising
a holding unit configured to hold reference data for the reference member, wherein
the calculation unit
calculates an offset value using the reference data and image data that correspond to pixel data adjacent to pixel data that has been determined as a singularity pixel, the image data pertaining to the reference member and being read by the sensor, and
replaces the pixel data that has been determined as the singularity pixel with a result of correcting a value of the reference data corresponding to a position of the pixel data that has been determined as the singularity pixel using the offset value, and causes the summation unit to perform the cumulative summation using a result of the replacement.

4. The original reading apparatus according to claim 1, further comprising
a notification unit configured to issue an error notification indicating a failure in the calculation of the shading correction data if a count of pixel data other than pixel data that have been determined as the singularity pixel is smaller than the predetermined number at one or more of the main-scanning positions on lines along a main-scanning direction upon completion of processing by the determination unit and the calculation unit over a prescribed number of lines.

5. The original reading apparatus according to claim 1, wherein
the calculation unit calculates the shading correction data for each of the main-scanning positions using an average value of pixel data that are at the main-scanning position on lines along a main-scanning direction and that are other than pixel data that have been determined as the singularity pixel.

6. The original reading apparatus according to claim 1, wherein
the determination unit determines that, among pixel data constituting image data of the reference member, pixel data having luminance value outside a predefined range is the singularity pixel.

7. The original reading apparatus according to claim 6, wherein
the range is defined by fixed values.

8. The original reading apparatus according to claim 6, wherein
for each of the main-scanning positions on lines along a main-scanning direction, a reference value is defined, and the range is defined as a predetermined range based on the reference value.
